(19) United States
(12) Patent Application Publication
(10) Pub. No.: US 2009/0307079 A1
(43) Pub. Date: Dec. 10, 2009

(54) METHODS AND SYSTEMS FOR PROVIDING ADVERTISEMENTS

(75) Inventor: Russell W. Martin, JR., New York, NY (US)

Correspondence Address: MORGAN LEWIS & BOCKIUS LLP, 1111 PENNSYLVANIA AVENUE NW, WASHINGTON, DC, 20004, US

(73) Assignee: Cross Commerce Media, Inc., New York, NY (US)

(21) Appl. No.: 12/135,788

(22) Filed: Jun. 9, 2008

(51) Int. Cl. G06Q 30/00; G06Q 40/00

(52) U.S. Cl. 705/14.36; 705/26; 705/40

(57) ABSTRACT

A system for facilitating product and services distribution, the system including a system processor for receiving and processing data associated with promotional indicia that is placed on a mailing, and for processing data associated with feedback from recipients of the mailings. The promotional indicia include a code associated with the mailing recipient and information associated with a communication portal. A communication channel connects the recipients to the system processor via the communication portal. An advertising method is provided including providing advertisement indicia on a mailing or other display. The indicia are customized for a recipient and include a promotion, code, and portal information. Use of the code in the portal is analyzed. Also described herein are auction systems for facilitating offers and sales of advertising space, and envelopes pre-printed with advertising indicia.

Every month, hundreds of thousands of individual mailings are sent out to selectively addressed households and businesses with personalized information for that recipient. These mailpieces typically are sent by first class or regular class mail and enclose individualized statements of accounts including billing status or other personal and important information for the recipient regarding transactions from the prior period of time. This correspondence is generated in the ordinary course of business by numerous businesses including banks, brokerages, credit card companies, and utilities such as oil and gas companies, electricity suppliers, telephone companies and cable TV suppliers. It is a practice that has been ongoing for decades with little change.

A typical household, business, or other recipient may receive ten or more of these periodic transaction letters during any given month. In addition to these transaction letters, a typical recipient may be swamped with dozens of promotional mailings—that is, mailings in the form of acquisition letters, flyers, bulletins, cards and catalogs full of mostly unsolicited marketing messages related to various products, services and merchandise. These mass mailings are mostly untargeted and involve offers and perhaps even discounts on various products—but products that for the most part are simply not of any interest to a majority in the receiving household or business. Since these mailings do not interest recipients, such promotional marketing methods are extremely inefficient for advertisers.

As such, most recipients partake in the ritual of separating the junk from the important mail, using a simple process of examining individual mailings and disposing of the unsolicited commercial pieces. Solicited mailings, such as transaction letters, however, are preserved with any personal correspondence and other more valuable delivered materials—often to be reviewed later while filing or bill paying. In short, the solicited mailings survive an initial screening process and hold a far higher level of subsequent reviewer attention.

Of course, the disposed-of unsolicited commercial pieces (junk mail) represent a horrific waste of natural resources. Thousands of tons of paper are wasted every year in flooding the markets with unsolicited offers having almost no utility to the receiver and providing an inefficient means of business generation and promotion for the sender. As the true cost of these wasted resources becomes more apparent, both in respect of wasted natural resources and inefficient spending of marketing dollars, the elimination or reduction of this wasteful practice offers significant environmental and economic benefits.

Past efforts to eliminate or address the foregoing have largely been unsuccessful.

### SELECTED EMBODIMENTS OF THE PRESENT INVENTION

Without restriction, a present approach for practicing the invention provides an integrated system of computers, databases, data processors and network-based software that collectively support operative data processing to permit selective creation and delivery of targeted marketing messages to individuals, households, businesses or other recipients, without corresponding junk mailings and the associated system support for tracking and quantifying promotion success and valuation. Certain embodiments of the invention are directed to creating and supporting an offline to online promotional network. Other embodiments of the invention are directed to providing an auction venue or other source for promotional space. Yet other embodiments of the invention are directed to providing advertising and promotional networks. The foregoing embodiments are disclosed in the following detailed description including system diagrams and programming flowcharts depicting the operative characteristics of this embodiment of the present invention.

Specifically, for the embodiments, the system includes the creation of a promotion on a space or location, for example on an outer surface of a letter envelope that includes at least the following three pieces of information. First, a product or service offering is identified with an advertisement or enticement to drive customer or recipient interest. Second, a communication portal, such as a consumer portal, customer interface, or website, is identified allowing a fast and easy path from the offline promotion to an online portal such as a web page or similar link for data entry. Third, an identifier, such as a code, series of numbers, letters or symbols, a two-dimensional or three-dimensional bar code, or other identifier is provided that is easily entered into the portal.

This embodiment is further described in conjunction with the following figures.

### BRIEF DESCRIPTION OF THE DRAWINGS

FIG. 1 depicts a system operation diagram for implementing the present invention;

FIGS. 2A-B depict envelopes including an advertisement according to embodiments of the invention;

FIG. 3 depicts an overview diagram of an embodiment of the invention;

FIGS. 4A-B depict websites according to an embodiment of the invention; and

FIG. 5 depicts user options and activities for a website according to an embodiment of the invention.

### DETAILED DESCRIPTION

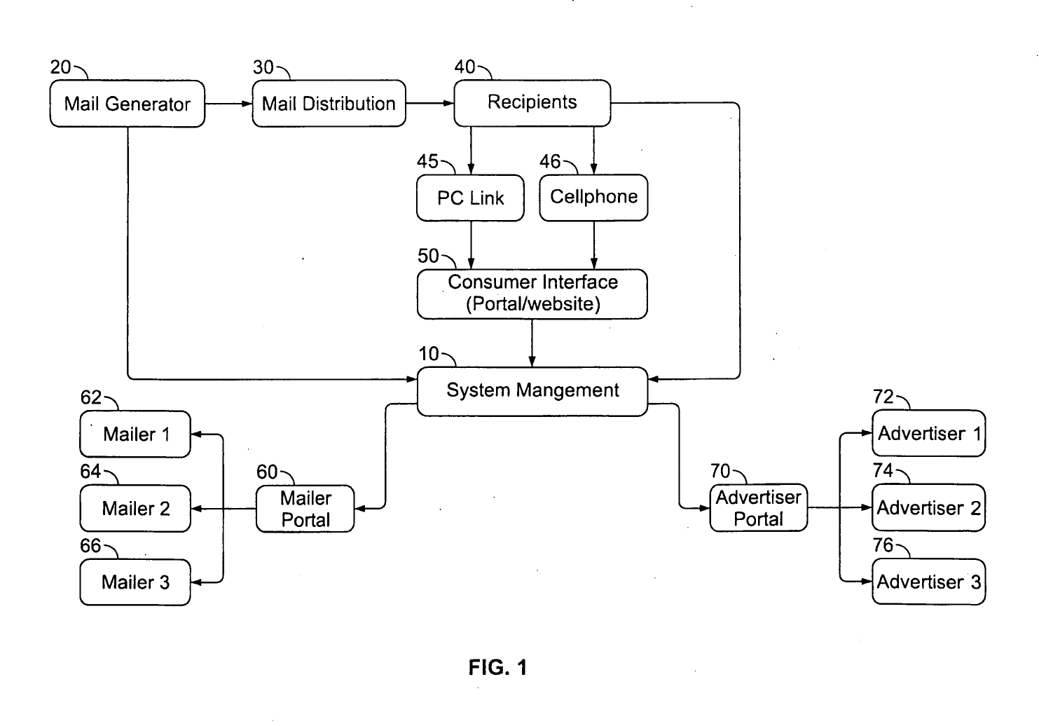

Turning first to FIG. 1, a system overview is presented for one of the embodiments of the present invention. Specifically, at the system core is a management module 10 for implementing operation controls for system functions. In a first function, management software generates a promotion package which can be any type of promotion for an advertiser that will be distributed via a mailer's mailings. In general, the advertiser may be any type of company, individual, or other entity using the advertising and promotional functionality described herein. The mailer is typically a company, business or other organization with periodic mailings, such as a credit card company, educational institutions, utility company, but may also be an individual or other entity with or without periodic mailings.

The promotion package usually includes digital, electronic or other information regarding the form of promotion to be applied to the mailing, its location and optionally, the individual or regional selection of mailing that will receive the promotion and is delivered to a mail generator, block 20. The mail generator 20 may be a printer or print producer.

Block 20 generates the deliverable product that includes the promotion. The integrated deliverable is then sent to mail distribution module 30, and ultimately delivered to recipients 40. The recipient views the promotion and, based on the selectively applied information, the recipient accesses the system via a web connection and system customer interface (website), or via another interface or method, e.g., using different devices and techniques such as SMS/Text Messaging using a cellular telephone, Interactive Voice Response using a phone, Fax, etc. 50. The communication link can include various channels such as PC/link 45 and cell phone link 46, or other link.

At block 10, system management receives the communications from the recipient and processes the data, often resulting in some form of return back to the recipient of a discount or promotion, which may include, for example, a preview of products, watching a movie preview trailer, playing an electronic game, information about a product, samples of a product etc.

The deliverable product is generally produced on an envelope for a solicited mailing by a mailer which may be provided via a mailer portal 60. Mailers 62, 64, 66 can include an entity with periodic or other mailings, such as banks, utilities, financial institutions, educational institutions, credit unions, newspapers and magazines, small businesses, individuals or other entities that generate the mailings, such as periodic account statements, or other non-periodic mailings. Promotion concepts to be used on the mailings may be generated by sponsoring advertisers 72, 74 and 76 and details of the same may be transmitted to the system management 10 via advertiser portal 70.

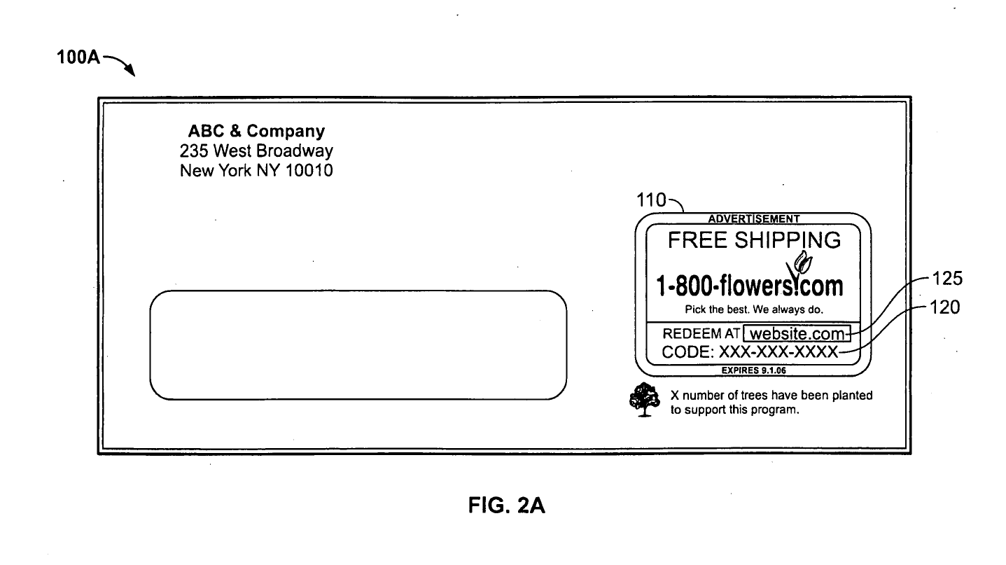

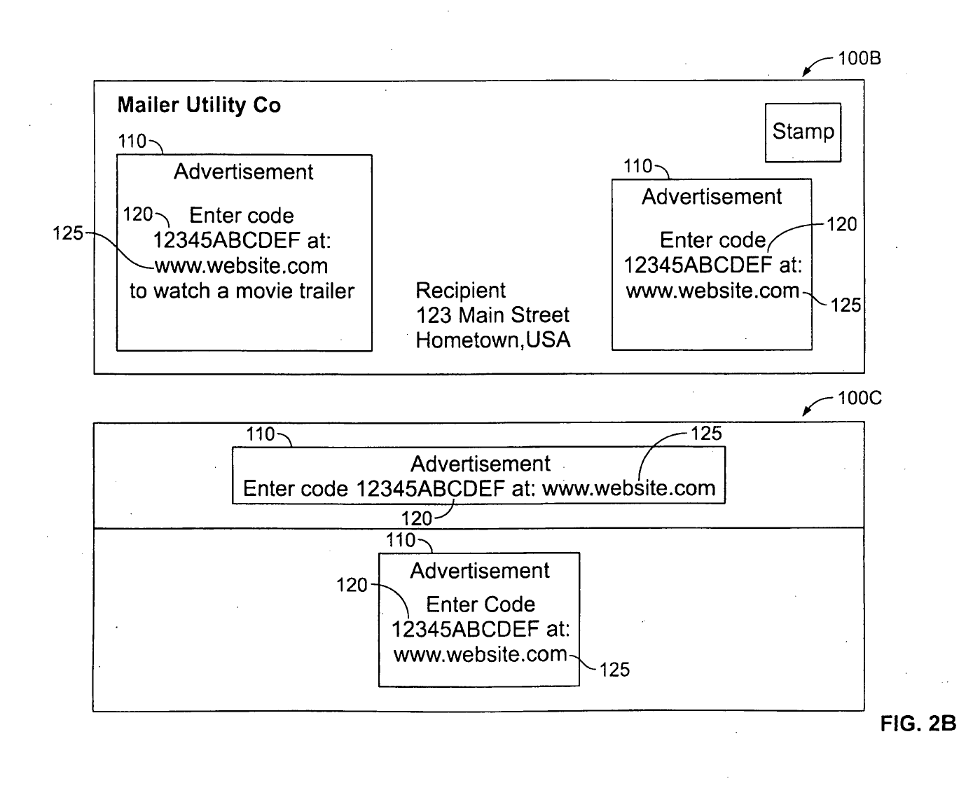

Turning to FIGS. 2A and 2B, embodiments of the invention provide a customized advertisement printed on an envelope 100 having a front side 100A/B and/or back side 100C. In some embodiments, as shown in FIG. 2A, the customized advertisement may be printed on a mailpiece and viewable through an envelope window. The envelope 100 may be any type of envelope, for example, an envelope with a window or without. In some embodiments, envelope 100 is for a mailing that is destined to be mailed, even without an advertisement printed on it. For example, envelope 100 is for a periodic utility or bank statement. Envelope 100 is designed to have one or more advertisement or promotional indicia 110 which can include any kind of promotional information. The term indicia is used herein in a broad sense, including any type of marking. The promotional indicia 110 may include a code 120, which can be any combination of letters, numbers, symbols, or barcodes and may be used to provide access to a promotion. For example, code 120 may be a coupon code, an access code, or other code. Code 120 may be entered at a point of sale, website, telephone dial-in, text message, or via cell phone scanning, single/multidimensional scanning or other point. Such codes may be associated with a customer, mail batch, etc., and code usage may be tracked.

The advertisement indicia 110 is preferably designed to comply with postal regulations and provide an appealing graphic. The advertisement typically includes promotional information and may include a website address 125 (or other location, venue, consumer/customer portal site, or point of sale), promotion code, and other information. As will be understood by one of skill in the art, more than one promotional indicia 110 may be printed on a single envelope 100. If more than one promotional indicia 110 is printed on the envelope 100, the indicia 110 may be the same or different based on location, advertiser, recipient, or other parameter.

In some embodiments of the invention, envelope 100 is custom print by a mail generator or printer as part of a promotion package. In other embodiments of the invention, envelope 100 is sold pre-printed with promotional indicia 110 thereon and provided for example, via retail to individuals or small businesses generating mailings, or provided to mail generators for batch printing mailings, or other distribution points.

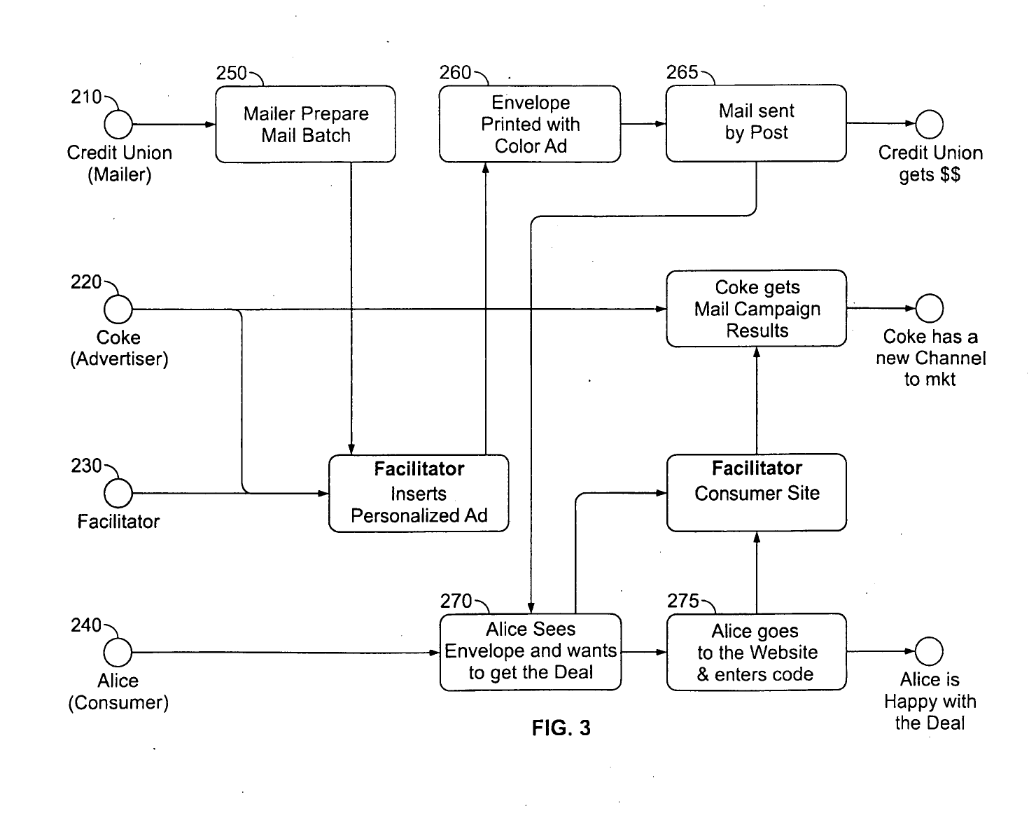

FIG. 3 depicts an overview illustration of parties and certain events according to some embodiments of the invention. As shown, there are generally four entities involved in embodiments of the invention. (Greater or fewer than four entities may also be used in embodiments of the invention as will be understood by those of skill in the art.) These entities are usually a mailer 210, advertiser 220, facilitator 230, and user 240. Mailer 210 is typically any entity that can provide advertising space, for example, on an envelope. For example, mailer 210 may be a periodic (or non-periodic) mailer of letters, e.g., utility statements, bank statements, other services, etc., that have blank space on the letter envelope which can be used for printing advertising indicia. Mailer 210 may also be an individual or other entity sending a non-periodic mailing. As will be understood by one of skill in the art, the inventions described herein may be used in other scenarios and the Mailer 210 term may be applied to providers of other types of advertising space, e.g., billboards, signage, magazines, newspapers, preprinted envelopes, other print media, etc.

Advertiser 220 may be any entity that wishes to advertise. Typically the advertiser 220 is an entity that is different than mailer 210. For example, a third party, such as a food and beverage vendor, apparel or other type of producer, a movie studio, or other entity could send targeted advertisements to recipients, such as customers of a financial institution, by way of, e.g., a printed advertisement on a credit card statement envelope. Of course, the same techniques described herein could be used to promote the mailer 210. For example, an electricity provider could print an advertisement or other promotion, such as energy audits or recycling events, on an envelope for their monthly statements.

Facilitator 230 is an entity that facilitates linking of mailer 210 and advertiser 220 for advertising promotions. Facilitator 230 may also provide websites or consumer access portals described herein and also systems for tracking recipient use of promotional materials, and providing advertising and promotional enhancements. For example, the facilitator 230 may track a recipient's entry of a code in a customer interface or consumer portal, and provide real-time information measuring effectiveness of an advertising campaign. Facilitator 230 may also provide, utilize, and support system management modules and functionality described herein. Finally, user 240 is a recipient of the advertisements, and is often a consumer or corporation on a mailing list of mailer 210, e.g., a bank account holder, utility service user, etc.

As shown in FIG. 3, a mailer 210 may have a mail batch prepared 250, which can include any number of activities for creating envelope batch printing, such as sending recipient information to an envelope printer, generating graphics, e.g., sender logos, promotion codes etc. In some embodiments, facilitator 230 may provide assistance with sourcing batch preparation. In some embodiments of the invention, a database of recipients is provided to an envelope printer. The envelope printer runs a print batch of envelopes for the bank or utility and prints recipient addresses on the envelopes for the bank or utility. The print batch is configured to print an advertisement or other promotional indicia including barcodes or other codes on the outside of the envelope.

An advertiser 220 and facilitator 230 may work together or independently to create an advertising or promotional campaign. Such advertising ideally complies with any postal service requirements for graphical or textual representations on mailers, e.g., envelopes, parcels, cards, etc. Such advertisement may also include information which may cause the recipient to visit a website, consumer portal, venue, or point of sale, or take an action, such as visit a store or restaurant, or call a telephone number, or other action that is specific to the recipient. Facilitator 230 will typically provide some input on advertisement design with respect to, for example, website information, codes, trackable indicia, and other design guidelines for complying with postal regulations, etc. The advertisement or other promotional indicia provided in embodiments of the invention can be any type of advertisement, such as a graphical depiction, writings, or other indicia conveying a promotional message. Some embodiments of the invention provide advertisements that may include codes which may be entered at a point of sale, website, telephone dial-in, text message, or scanned as a barcode, or entered at another point. Such codes may be associated with a user, mail batch, etc., and code usage may be tracked. As mentioned herein, tracking can provide a real-time measure of effectiveness and demographic usage of a promotional campaign. The advertisement is preferably designed to comply with postal regulations and provide an appealing graphic. The advertisement typically includes promotional information and may include a website address (or other location, venue, or point of sale), promotion code, and other information.

The mailer may also assist in mail batch preparation and provide access to the advertising print location, e.g., envelopes for periodic mailers. In general, the facilitator and/or the advertiser develop the advertisement or promotional material to ensure that it is both an effective advertisement and complies with postal requirements. The promotional material also typically provides a conduit for offline promotion to an online portal. The conduit may be provided via an enticement in an offline setting that causes a recipient to take an action, such as visit an online customer portal. The advertiser may select one or more recipient parameters, including addressee specific parameters, such as geographic or demographic parameters, and the type of mailer company, e.g., non-profit, utility, financial institution, etc., with which the indicia will be included. In some embodiments, indicia may be suppressed and not printed on an envelope based on a request of a recipient, mailer, advertiser, or based on another factor or reason.

Embodiments of the invention may be provided by processing one or more mailing lists and generating one or more promotions for recipients on the mailing lists. Different versions of advertisements or promotional indicia may be customized or tailored for recipients, e.g., based on location, demographics, etc. Such customization can include graphical changes, discounts or promotions offered, different codes (which may be associated with the recipient or group of recipients), etc. Such association between a code and recipient may be stored for tracking and analysis purposes.

A relevant mailing list for the mailer company is identified and the mailing information is sent to a printer together with the promotional indicia. As discussed herein, more than one version of promotional indicia may be customized for a mailing list or portions of a mailing list, such as by blocks of recipients, or even single recipients. The promotional indicia and recipient can be associated, and information relating to the association is stored for analysis purposes.

The printer creates envelopes including addressee information and the promotional indicia. The printer may omit the promotional indicia in the event the addressee has opted-out of advertisement or marketing information. The promotional indicia are associated with the individual addressee, or batches of addressees or other configuration as will be understood by one of skill in the art. In some embodiments, one or both of the addressee and promotional indicia are printed on either of the outside face of an envelope, or are visible through a transparent window in the envelope.

In some embodiments, the printer may also insert statements, letters, notices, or other correspondence in the printed envelope, and then may mail the envelope on behalf of the mailer company.

As mentioned previously, the promotional indicia may include one or more codes which can be used in an advertising portal and tied to the user profile including; name, used id, email, cell phone etc. The advertising portal may be a website or provided via another interface, such as SMS/text messaging, phone, fax, PDA, etc., that is provided by the advertiser, facilitator or other entity. Generally, the portal will support tracking of code entry data and track any subsequent purchases or lack thereof. Such tracking information may be reported to the facilitator and or advertiser, and accessed via an interface provided by the facilitator or other entity. The tracking information may be used to establish fees and rates for future campaigns and also provide metrics for advertisers use. Certain metrics and analytics for code usage, user behavior, and other elements of a campaign, may be provided based on tracking data and associated addressee information, etc.

The facilitator 230 inserts the advertisement into the mail batch design 250 and envelopes are printed 260 including the advertisement and any recipient sender information provided by the mailer 210. The printing process may occur in one or more batches, for example, printing of advertising indicia may occur at the time addressee information is printed, or at a different time. The printed envelopes are then mailed 265.

The user 240 receives the envelope 270. The users 240, or recipients of mailings described herein are typically a customer base for banks, utilities, credit card companies, or customer of other company that provides periodic mailings. These users are often already inundated with promotional inserts included within an envelope and typically overlook and dispose of the inserts without further inspection. Embodiments of the advertisements discussed herein are designed to avoid being overlooked and can be printed on the outside of an envelope (or visible through a transparent window in the envelope). Printing an advertisement on the front of the outside of an envelope is advantageous over an insert because recipients often view the front of an envelope to confirm that they are the addressee and also to check sender information. Some embodiments include printing promotional indicia on the back of an envelope, which is another location likely to be viewed by a recipient that opens an envelope from the back. (See FIG. 2). As mentioned herein, more than on promotional indicia may be printed on one envelope. In some embodiments, the different versions of promotional indicia on one envelope may be for the same advertiser providing more than one impression or viewing location for promotional indicia for the recipient. In other embodiments, the different versions of promotional indicia may be for more than one advertiser. Some users 240 may be interested in the advertisement and follow instructions therein, such as go to a consumer portal website and enter a code 275.

It is envisioned that recipients of the envelopes will view the promotional indicia and be persuaded to follow the promotional message. For example, the promotional indicia may say, “enter code ‘12345’ at ‘www.website.com’ to watch a movie trailer”. Since the code is associated with the recipient, if the recipient goes to the consumer portal website and enters the code, the information may be tracked for advertising intelligence purposes, e.g., effectiveness of advertising campaign, rate of sale, percentage of sale, etc. Similarly, the failure to use a code associated with a recipient may also be tracked for intelligence purposes.

Some of the advantages provided by the inventions described herein include that a mailer 210 receives payments for otherwise unused advertising space, e.g. blank space on periodically mailed statements, an advertiser 220 has a new advertising outlet, a user 240 receives information and value items in the advertisement, and facilitator 230 receives a payment. Other advantages include that embodiments of the invention are directed to providing an add-on advertisement to a pre-existing product or mailer so that new media, paper or other resources are not necessary to support the advertisement. As such, embodiments of the invention provide an environmentally sensitive promotional outlet. Few additional resources are expended in producing advertisements as described herein. For example, utility statements are sent to customers periodically. Printing an advertisement on the envelope for the statement does not require substantial additional use of resources because the envelope would have been used for the mailing anyway. In comparison, an advertisement flier mailed to a recipient or an envelope insert all require dedicated paper or other medium upon which the advertisement is printed.

Other advantages provided by embodiments of the present invention are customer targeting/customization, offline to online advertising user tracking and connections, advertisement feedback (e.g., based on tracked information, advertising effectiveness information, etc.), advertising space auction and value estimates, and other advantages. Real-time measures of promotional efficiency can be provided by tracking recipient code usage. This recipient information may also be analyzed based on demographic and other information known about the recipient.

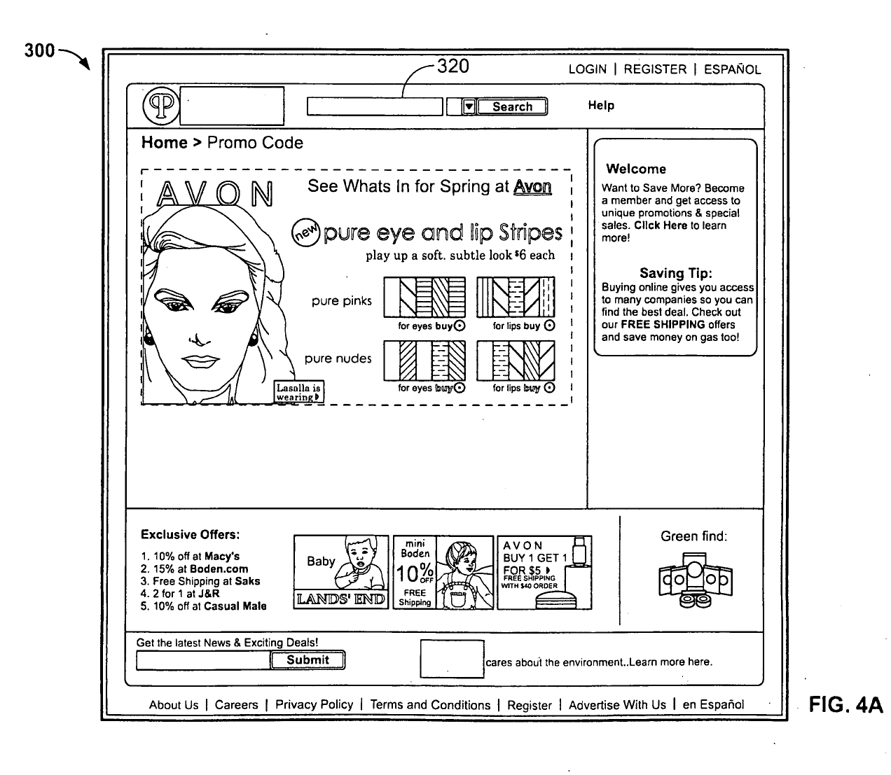

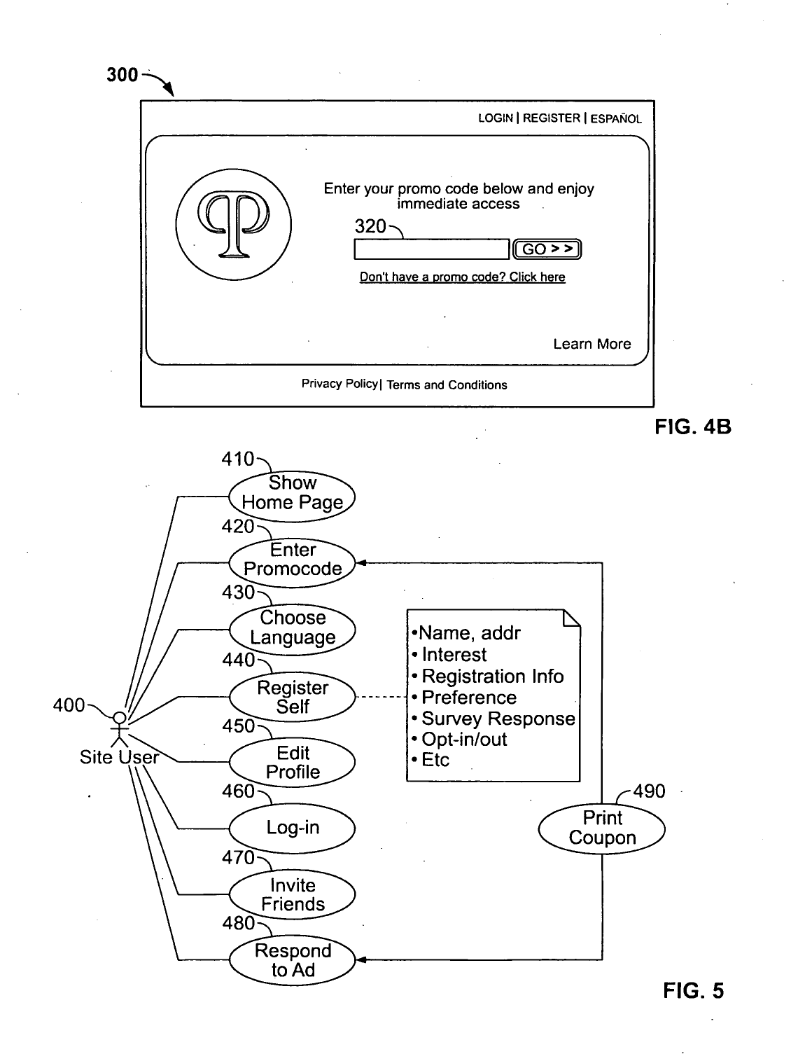

Examples of a consumer portal website used to enter a code are depicted in FIGS. 4A-B. As shown in FIGS. 4A-B, a website 300 may be provided with a user interface which allows a user to enter a code in box 320. Entry of the code in box 320 when activated can cause a user (e.g., the envelope recipient) to access the promotion advertised in promotional indicia 110. For example, a user may be directed to an advertiser's website, to a contest website, or to another location where a promotion may be accessed. The consumer portal is also designed to track the user's use of the code. The consumer portal and supporting on-line systems can be configured in any number of ways and include linking to other websites, e-commerce opportunities, and other devices, such as cellular telephones, bar code scanners, phone, fax etc., all of which may be tracked for feedback, audit or other purposes.

An exemplary consumer portal typically provides a user with selectable links to an advertisement, which may be viewed by entering a promotional code (e.g., a code printed on the envelope). The advertisements are targeted and customized for the viewer based on the entered code, user registration information, previous usage, or a combination of some or all of these. Advertisements may also be viewed without entering a code, e.g., by selecting a link to promotions or selecting a button for “no code”, etc. These advertisements can be customized based on user registration information, IP information, device information, or other data. Users may also select a link for searching for a code for a certain promotion and also view relevant advertisements.

Selectable links are also provided so that a user can register on the consumer portal website, which may provide customization options for the user, e.g., language, demographics information, etc. User registration information may be used to track a user's use of the personalized promotional codes and other online activity as well as customize advertisements and promotions displayed to the user. Selectable links may be provided in many ways as would be understood by one of skill in the art, for example, using links, drop down menus, selectable buttons, etc. Some links may be selected by users to access advertisement or promotions.

Turning to FIG. 5, a consumer portal website user 400 may access a website to view a home page 410. The website URL may be one included in promotional indicia on an envelope, or advertised in some other manner. A user 400 may enter a code 420 in the website, which may cause a coupon to be provided 490. The coupon may be printed and used in an off-line setting, or redeemed online, etc. In general, the website may also provide user customization and registration options. For example, a user may select a language 430 in which to view the website. A user may also register 440 on the website, which usually involves providing personal information, such as name, address, and other information, such as personal preferences, interests, survey responses, advertisement opt-in/opt-out, etc. Registration may be provided in stages, such as via incremental registration, where a user is presented with benefits or incentives to supplying personal information in stages, and users may supply varying amounts of personal information based on, e.g., user preference. The website also typically includes links for editing a user profile 450 and for logging in to the website 460. Logging into the website facilitates tracking of user activities, including code usage and transactions. Such tracking may also be provided without user log-ins, e.g., using cookies and other techniques known in the art. In some embodiments, users may invite friends 470 to view the website, or to take advantage of a code, coupon, other promotion, etc. In certain embodiments, users may be awarded points or other value item when inviting friends, for friends' activities, for viewing certain promotions, for taking selected actions (e.g. printing, purchases, supplying information), etc. In some embodiments, a user may respond to an advertisement 480 in one or more ways, including entering a code, or other manner. Responding to the advertisement or other promotional indicia will typically lead to a coupon or other value item.

A user's use of a website is typically tracked. For example, when a user logs in, data regarding the user's transactions are stored and analyzed. A user's use of a code may also be tracked and analyzed. Advertising intelligence, tracking information, etc., maybe used to support auction-type, or calculations for a scale of fees for providing promotional materials described herein. For example, advertising directed to certain mailing list recipients may command a certain fee which may be greater (or less) than that of another group of mailing list recipients. Such scale of fees may be based on historical information of past promotional campaigns, certain demographic information, or other basis. Such fee information may be used in estimates for services, in advertisement campaign auctions, etc.

An embodiment of a consumer portal in communication with a system management module is typically designed to support or facilitate, for example, the following:

User Management—storing and analyzing user information, including preferences, demographics, etc.

Action tracking—code usage from certain envelopes, subsequent transactions, advertisement selections, link selections, affiliations, etc.

Closed Loop Feedback—providing personalized content to users and feedback to advertisers on advertising campaigns.

Behavior Analysis—provide analysis of user behavior to improve online advertisements.

Comply with Regulatory, Privacy and Security requirements.

Provide international globalization support.

Support access via a plurality of devices, e.g., computers, handheld devices, cellular telephones, etc.

Support for different and a plurality of media outlets, including, for example, envelopes, newspapers, billboards.

Provide customized content for viewers based on past actions.

Embodiments of the website alone or in conjunction with the facilitator and/or system management modules are designed to provide reports and analytics of advertising campaigns, for example, advertiser campaign & targeting analytics, operations dashboard—revenue, costs, trends, reports of a master database, ad network, advertisement effectiveness/success etc., supports envelope printing, and other functions.

In general, the facilitator provides a service connecting a mailing company, such as a utility, financial institution, or other company or organization that sends periodic mailings, and an advertiser, which can be any company, entity, or organization seeking a promotional outlet. The facilitator may also provide a design service for providing an envelope-appropriate advertisement that complies with postal requirements. The facilitator typically is able to communicate data, including mailing list information, demographics, advertisement tracking information, advertisement graphics information and other data between a company (mailer), advertiser, and envelope printer. In some embodiments, the facilitator may also provide a support in providing one or more websites in which promotional codes may be entered and tracked. The facilitator will also usually store data related to each promotion for audit trail and reporting purposes.

Other services provided by a facilitator include providing promotional analytics and intelligence processing. For example, certain demographic information may be associated with an addressee or mailing list recipient, or group of recipients, their respective code usage, and other information, may be processed. The facilitator may also provide certain customer service assistance, for example, for sweepstakes, discount code issues, or other assistance. Facilitators may also manage printers to ensure quality of print jobs, data security, and timeliness of process, etc.

A facilitator or other entity may also provide auction services for selling advertising space. The facilitator may use historical data based on completed mailings and advertising campaigns to estimate value of potential advertising space. For example, the estimate may be based on the source of mailing list, demographic information associated with mailing list recipients, historical behavior for similar advertising campaigns, etc.

A facilitator or other entity may also perform advertising campaign management including selection of publishing inventory spaces, managing and/or directing creative development, budget and billing, targeting and optimizing advertisement functionality, testing services, advertisement analytics, delegation function, regulatory compliance management, print management, multi-media channel support, and international support.

Embodiments of the invention are provided by printing promotional indicia on the outside of an envelope supplied by a mailer. A mailer is generally an entity that provides periodic mailings, such as a bank, credit card company, utility, club, etc. In general, the mailer is continuously creating periodic mailings directed to its customers. Mailers typically have the ability to provide mailing list data including: Unique Account Identifier, Account Name, Address, Zip Code, and other data. The mailer typically provides data security to protect mailing lists, and other data relating to the print batch. The mailer may also provide information indicating which of its mailing list addressees may have opted out of receiving marketing materials.

Security and regulatory compliance may be provided by the facilitator, printer, mailer, and other relevant entity. In general, embodiments of the invention are designed to comply with local and national regulations regarding consumer information safeguards and confidentiality. To provide such security, for example, a facilitator or mailer may identify security control points for data transmission and vulnerabilities and implement safeguards or other controls, provide security procedures relating to sensitive account information, (e.g., name, address or telephone number, which together, or in any combination with, a social security number, driver's license number, account number, credit or debit card number, or a personal identification number or password that would permit access to the individual's account.)

A website can be provided by the advertiser, the facilitator, or other entity. The advertising website typically supports use of the codes provided in the promotional material and tracking processing. Entry of the code into the website can cause the user to be directed to the advertiser's website or other point of sale.

Embodiments of the invention typically provide advertising and promotional targeting by several geographic, demographic or other parameters. Examples include: address, zip code, city, state, age, sex, marital status, employment, industry, and ethnicity. Other targeting parameters include frequency of mailing cycles, e.g., monthly credit card statement mailings, quarterly mutual fund statements, semi-monthly utility statement mailings, etc. Other restrictions may include that the targeting system can permit advertisers to restrict or request certain types of mailings, e.g., invoice, statement, or notice. Similarly, advertising campaigns can be matched to certain mailer industry types, e.g., non-profit, financial, utility.

Advertising campaigns and advertisement performance is tracked and audited to, among other things, evaluate effectiveness of the campaigns. Tracking information may be used as a basis for pricing and auctioning envelope space for promotions. Tracking information may also be used to provide certain metrics for designing promotion campaigns.

In some embodiments, a facilitator and/or facilitating website can support designing an advertisement campaign and payment for the campaign. The website can also provide an interface for an advertiser to obtain real-time tracking information for an advertising campaign. The interface may also be used to create reports and other analysis for a campaign.

Some of the metrics and other data tracked in a promotional campaign include, for example: retrieval (codes retrieved/delivered impressions), redemption per ad (coupons printed (or ads-clicked) per delivered impressions), redemption abandonment per ad (coupons not printed/or codes not retrieved), return on investment conversion. e.g., targeting attribute selected, targeting attributes not-selected, comparison with other advertisers/campaigns in mail-stream, comparison with other advertisers/campaigns in other mail-streams, and other metrics.

Some embodiments of the invention are directed to providing a marketplace for mailers and advertisers. In this marketplace, Mailers provide the publishing spaces (i.e. inventory) on media such as envelope, magazines, billboards, etc., and advertisers buy Inventory spaces for promotions. The facilitator provides, among other things, systems, matching of advertisers to inventory, software, interfaces, communications, and exchange of funds between the buys and sellers in this marketplace. Thus some embodiments of the invention provide an auction service for bidding on and purchasing rights to advertise on mailer's envelopes. Other embodiments of the invention provide analytics and performance estimation for promotional campaigns.

Although most embodiments described herein involve printing promotional indicia on envelopes supplied by a company or mailer, the inventions described herein may be adapted and applied to billboard applications, other print medium, cellular distribution, electronic mail distribution, or other medium, as would be understood by one of skill in the art.

It will be appreciated that the present invention has been described by way of example only, and that the invention is not to be limited by the specific embodiments described herein. Improvements and modifications may be made to the invention without departing from the scope or spirit thereof.

Embodiments of the present invention comprise computer components and computer-implemented steps that will be apparent to those skilled in the art. For example, calculations and communications can be performed electronically, and agreements can be composed, transmitted and executed electronically.

For ease of exposition, not every step or element of the present invention is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the present invention.

What is claimed is:

1. A computer system for facilitating distribution of a promotion, the system comprising:
a. a system processor for receiving and processing data associated with a promotional indicia to be placed on an individualized mailing generated by or for a mailer, and for processing data associated with feedback from recipients of the individualized mailings: wherein the promotional indicia comprises a code associated with a recipient of the mailing, and information associated with a communication portal; and
b. a communication channel connecting the recipients to the system processor, via the communication portal.

2. The computer system of claim 1 further comprising a communication channel between mail generators and the system processor for communicating data regarding printing the promotional indicia on the individualized mailings.

3. The computer system of claim 1 further comprising a communication channel between an advertiser portal and the system processor for communicating data regarding the feedback from recipients of the individualized mailings.

4. The computer system of claim 1 wherein the promotional indicia is viewable on an outside face of an envelope.

5. The computer system of claim 1 wherein the promotional indicia is displayed in an electronic format.

6. A computerized method comprising:
providing an advertisement indicia for printing on an envelope in a mailing, wherein the indicia is customized for at least one recipient and wherein the indicia comprises a promotion, a code associated with the at least one recipient, and information associated with a portal;
analyzing the at least one recipient's use of the code in the portal;
generating a report based on analyzing the at least one recipient's use of the code; and
based on the analyzing of the at least one recipient's use of the code, generating a second advertisement indicia online.

7. The method of claim 6 wherein the advertisement indicia is printed on an outside face of the envelope.

8. The method of claim 6 wherein the advertisement indicia complies with postal requirements and local requirements.

9. The method of claim 6 wherein the advertisement indicia promotes an advertiser.

10. The method of claim 9 wherein a sender of the envelope differs from the advertiser.

11. The method of claim 6 wherein the envelope is for a periodic mailing of non-advertising material.

12. The method of claim 6 wherein the code is used in a website.

13. The method of claim 6, further comprising providing a marketplace for auctioning envelope space for printing the advertisement indicia.

14. The method of claim 6, further comprising providing a third advertisement indicia for a recipient that has opted-out of advertising.

15. A method comprising:
providing an on-line auction facilitating offers and sales of an offline advertising campaign directed to a first recipient using a first offline advertising space;
estimating a value of the first advertising space based in part on an analysis of a prior advertising campaign using a second advertising space having at least one characteristic in common with the first advertising space, and a second recipient having at least one characteristic in common with the first recipient;
providing an advertisement indicia customized for the first recipient and the first advertising space; and
associating the advertisement indicia with the first recipient.

16. The method of claim 15 wherein the first advertising space and the second advertising space comprise a location on an outside face of an envelope for a periodic mailing of non-advertising material.

17. The method of claim 15 wherein the advertisement indicia complies with postal requirements and local requirements.

18. The method of claim 15 wherein the advertisement indicia promotes an advertiser.

19. The method of claim 18 wherein a sender of the envelope differs from the advertiser.

20. The method of claim 15 wherein the advertisement indicia comprises a code

21. The method of claim 20 wherein the code is used in a portal.

22. The method of claim 21, further comprising analyzing the first recipient's use of the code.

23. The method of claim 22, further comprising generating a report based on the analyzing of the first recipient's use of the code.

24. A method comprising:
providing a computerized advertising network for a recipient of an offline promotion comprising at least a code associated with the recipient, and an address of the advertising network;
analyzing data received from the recipient in response to the offline promotion; and
customizing a second promotion based on the analysis.

25. The method of claim 24 wherein the offline promotion comprises promotional indicia printed on an outside face of an envelope.

26. The method of claim 24 wherein the offline promotion comprises promotional indicia viewable on a display.

27. The method of claim 24 further comprising calculating efficiency of an offline promotion based on the analyzed data.

28. The method of claim 24 wherein customizing a second promotion comprises comparing recipient demographic information and the data received from the recipient in response to the offline promotion.

29. A method comprising:
providing a promotion via an advertisement indicia for display on a device, wherein the advertisement indicia comprises at least: a promotion, a code associated with a recipient, and an address of a portal;
analyzing data received from the recipient in response to the advertisement indicia;
generating a report of effectiveness of the promotion; and
customizing a second promotion based on the analysis.

30. The method of claim 29 wherein the device comprises one of the group consisting of: cellular telephone, personal digital assistant, hand held communication device, global positioning system device, electronic book, outdoor advertising display, and billboard.

31. The method of claim 29 wherein said code comprises at least one of the group consisting of: numbers, symbols, letters, and barcodes.

32. The method of claim 29 wherein the portal comprises one of the group consisting of: a website, and a text message portal.

33. The method of claim 29 further comprising providing an auction for providing the second promotion.

34. A computerized method comprising:
providing envelopes pre-printed with one or more advertising indicia, wherein the one or more advertising indicia comprises: a promotion, a code associated with at least one benefit, and information associated with a communication portal; and
analyzing use of the code in the communication portal.

35. The method of claim 34 further comprising receiving a payment associated with pre-printing the one or more advertising indicia.

36. The method of claim 34 wherein the one or more advertising indicia subsidizes a purchaser's cost of the envelope.
